(19) United States
(12) Patent Application Publication
(10) Pub. No.: US 2015/0113281 A1
(43) Pub. Date: Apr. 23, 2015

(54) MULTIPLE APPLICATION PLATFORM OWNER KEYS IN A SECURE OBJECT COMPUTER SYSTEM

(71) Applicant: International Business Machines Corporation, Armonk, NY (US)

(72) Inventors: Richard H. Boivie, Monroe, CT (US); Vincenzo V. Diluoffo, Sandy Hook, CT (US); Jeb R. Linton, Manassas, VA (US)

(73) Assignee: International Business Machines Corporation, Armonk, NY (US)

(21) Appl. No.: 14/135,964

(22) Filed: Dec. 20, 2013

Related U.S. Application Data
(63) Continuation of application No. 14/057,348, filed on Oct. 18, 2013.

(51) Int. Cl. H04L 9/32

(52) U.S. Cl. CPC H04L 9/32; H04L 9/3247
USPC 713/176; 713/168

(57) ABSTRACT

The computer system includes a first memory to store an executable file of a first application platform owner (APO). The executable file includes an owner identification object and an encrypted secure object payload. The computer system includes a key store having one nonvolatile key slot for each of two or more APOs. Each key slot stores one or more keys of a respective APO. The computer system further includes a processor configured upon receiving the executable file to identify a first key slot in the key store corresponding with the owner identification object. The first key slot is associated with the first APO. The processor is configured to determine whether the executable file is authentic using an APO key. Furthermore the processor decrypts the encrypted secure object payload using a first key of the first APO if the executable file is determined to be authentic.

### CROSS-REFERENCE TO RELATED APPLICATIONS

This application is a continuation of co-pending U.S. patent application Ser. No. 14/057,348, filed Oct. 18, 2013. The aforementioned related patent application is herein incorporated by reference in its entirety.

### FIELD

The present invention relates generally to protecting code and data on a computer system, and more particularly relates to the computer system having a plurality of application platform owner keys that are used for encryption/decryption, authentication, and integrity for each application platform owner.

### BACKGROUND

The Internet is one of the most powerful tools used today. It may be one of the most significant tools driving business, economic, and social change. However, like many tools the Internet is subject to errors and misuse. Protecting data and software on a computer system from other software, including software that an attacker may be able to introduce into a targeted computer system, is of concern.

### SUMMARY

One embodiment is directed toward a computer system. The computer system includes a first memory to store an executable file of a first application platform owner (APO). The executable file includes an owner identification object and an encrypted secure object payload. The computer system includes a key store having one nonvolatile key slot for each of two or more APOs. Each key slot stores one or more keys of a respective APO. The computer system further includes a processor configured upon receiving the executable file to identify a first key slot in the key store corresponding with the owner identification object. The first key slot is associated with the first APO. The processor is configured to determine whether the executable file is authentic using an APO key. Furthermore the processor decrypts the encrypted secure object payload using a first key of the first APO if the executable file is determined to be authentic.

In another embodiment a method of securely transferring objects from an application platform owner to a computer system is described. The method includes receiving, from a first memory, an executable file of a first application platform owner (APO). The executable file includes an owner identification object and an encrypted secure object payload. The method includes storing one or more keys of two or more APOs on a key store having one nonvolatile key slot for each respective APO. A processor identifies, upon receiving the executable file, a first key slot in the key store corresponding with the owner identification object. The first key slot is associated with the first APO. The executable file is determined to be authentic using an APO key. Also, the encrypted secure object payload is decrypted using a first key of the first APO if the executable file is determined to be authentic.

### BRIEF DESCRIPTION OF THE DRAWINGS

Embodiments are illustrated by way of example, and not by way of limitation, in the figures of the accompanying drawings in which reference numerals refer to similar elements.

FIG. 1 illustrates a block diagram of an exemplary computer system that provides support for a secure object, according to an embodiment.

FIG. 2 illustrates an block diagram of an exemplary executable file interacting with processing logic of the computer system, according to an embodiment.

FIG. 3 illustrates a block diagram of the exemplary logic within a hardware key store of the processing logic, according to an embodiment.

FIG. 4 illustrates a flow chart of a method of processing an executable file containing a secure object, according to an embodiment.

FIG. 5 illustrates a flow chart of a method utilizing an exemplary key scheme, according to an embodiment.

FIG. 6 illustrates a flow chart of a method utilizing another exemplary key scheme, according to an embodiment.

FIG. 7 illustrates an overview of operations that may be performed in various embodiments.

### DETAILED DESCRIPTION

Embodiments herein provide for a method and apparatus of a computer system having a plurality of application platform owner keys used in a decryption process of secure objects of one or more application platform owners within the computer system. Features illustrated in the drawings are not necessarily drawn to scale. Descriptions of well-known components and processing techniques are omitted so as to not unnecessarily obscure the disclosed embodiments. The descriptions of embodiments are provided by way of example only, and are not intended to limit the scope of the invention as claimed. The same numbers may be used in the Figures and the Detailed Description to refer to the same devices, parts, components, steps, operations, and the like.

U.S. patent application Ser. No. 12/492,738, filed on Jun. 26, 2009, to Richard H. Boivie, entitled “SUPPORT FOR SECURE OBJECTS IN A COMPUTER SYSTEM”;
U.S. patent application Ser. No. 12/878,696, filed on Sep. 9, 2010, to Richard H. Boivie, entitled “CACHE STRUCTURE FOR A COMPUTER SYSTEM PROVIDING SUPPORT FOR SECURE OBJECTS”;
U.S. patent application Ser. No. 13/033,455, filed on Feb. 23, 2011, to Boivie, et al., entitled “BUILDING AND DISTRIBUTING SECURE OBJECT SOFTWARE”;
U.S. patent application Ser. No. 13/033,367, filed on Feb. 23, 2011, to Boivie, et al., entitled “SECURE OBJECT HAVING PROTECTED REGION, INTEGRITY TREE AND UNPROTECTED REGION”; and
U.S. patent application Ser. No. 13/226,079, filed on Sep. 6, 2011, to Boivie, et al., entitled “PROTECTING APPLICATION PROGRAMS FROM MALICIOUS SOFTWARE OR MALWARE” are hereby incorporated by reference in their entirety as though fully and completely set forth herein.

Secure object technology has been created to protect data and information of an application from malicious software. A secure object, like objects in other object-orientated programming languages, contains data and code that manipulates and provides access to that data. Secure objects are encrypted data and instructions that may only be run by a targeted machine. Secure objects may be built by a build machine and sent to the target machine for processing. Once the secure object enters a processor of the targeted machine, the processor will recognize the data as a secure object, and enter into a secure mode for secure object execution. The processor may have one system key that unlocks encryption keys of the secure object. The encryption keys may unlock private data of the secure object to be executed “in the clear” by the processor.

As discussed in the applications incorporated by reference, the system key may be used for all secure objects from all programs and sources including, but not limited to, firmware, bootloader, operating systems, and application vendors. The single system key may be stored in efuse technology. The efuse technology is a permanent “write once” mechanism that can be used to store the system key, which needs to be written once but read many times. The process of writing the system key into efuses is performed at manufacturing time. However, system key data is under security threats from overly exposed usage, lack of rotation capability, and potential weakness due to limited resources.

Embodiments herein provide for an alternative secure object security implementation by supporting a hardware key store 114. The hardware key store 114 may include a nonvolatile memory. Key slots of the nonvolatile memory may be assigned to one or more application platform owners (APO) (developer or owner) for supporting secure object execution. One or more application platform owner keys (APO keys) may occupy the key slots for each APO. The nonvolatile memory may have advantages over an efuse implementation as it may support tamper logic. The tamper logic may provide the capability to erase key data on an event. The nonvolatile memory may also allow APO keys to be rotated and provides a larger store resource.

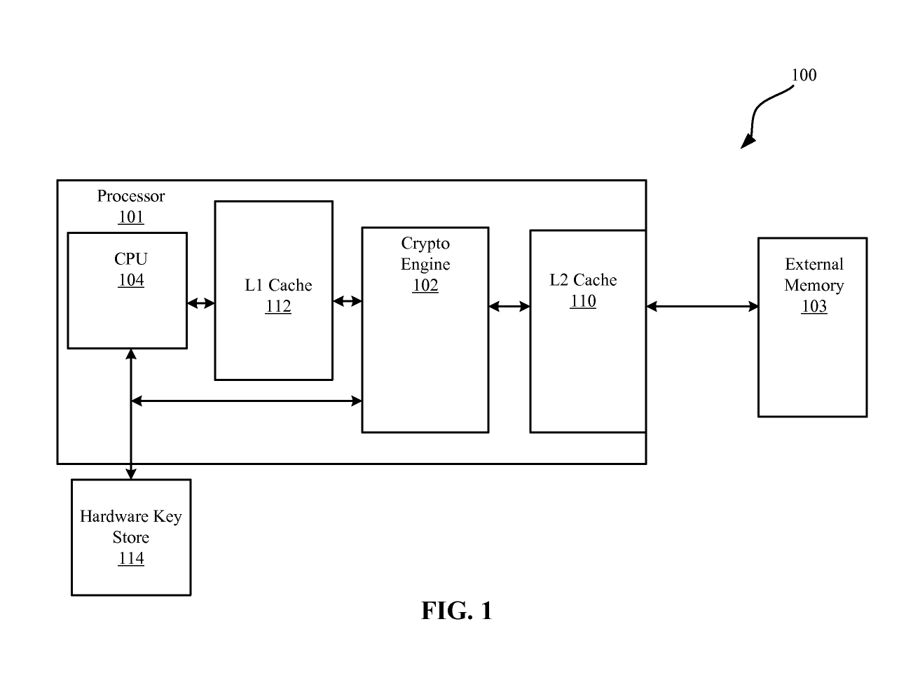

FIG. 1 is a block diagram of a computer system 100 that provides support for one or more secure objects. The system 100 may include a processor 101 and external memory 103. The processor 101 may include a crypto-engine 102 for (1) decrypting sensitive information as that information moves from external memory 103 into an L1 cache 112 and (2) encrypting sensitive information as it moves from the L1 cache 112 to external memory 103. This cryptography may be used to ensure that other software, including viruses, worms, and other “attack software”, will not be able to obtain the unencrypted version of sensitive information. It is noted that the crypto-engine 102 may be a coprocessor associated with a central processing unit (CPU) 104 or the crypto engine 102 could be a function executed by the CPU 104.

The processor 101 may be coupled with a hardware key store 114. The hardware key store 114 may hold a plurality of keys including an APO key, according to an embodiment. The hardware key store 114 may include a plurality of key slots in nonvolatile storage. Key slots of the hardware key store 114 may be assigned to an application platform owner (APO), e.g., developer or owner. Each key slot may contain an APO key or keys for encryption/decryption purposes and authentication/integrity purposes. In addition to a nonvolatile storage, the hardware key store 114 may include other logic that is further explained below.

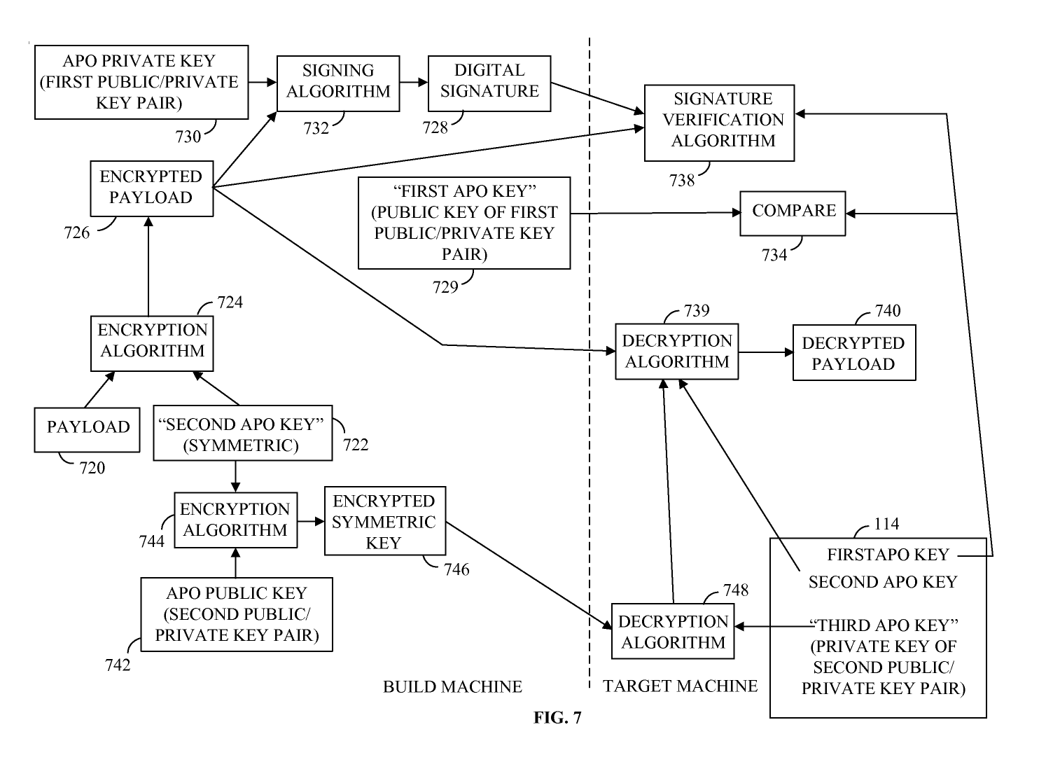

An overview of operations that may be performed in various embodiments is shown in FIG. 7. The hardware key store 114 may store a plurality of keys. For example, the hardware key store 114 may store first, second, and third APO keys. The first APO key may be a public key of a first public/private key pair. The second APO key may be a symmetric key. The third APO key may be a private key of a second public/private key pair. These example keys are shown as being stored in one key slot in the key store 114. The example APO keys shown in FIG. 7 are also used in various examples that follow in this Detailed Description.

Turning now to FIG. 7, a payload 720 may be encrypted using the second APO key 722 and an encryption algorithm 724. An encrypted payload 726 may be transmitted from a build machine to a target machine along with a digital signature 728. The digital signature 728 may be generated from the encrypted payload 726 and an APO private key 730 using a signing algorithm 732. The APO private key 730 may be a private key of the first public/private key pair. As further described herein, the encrypted payload 726 and digital signature 728 may be transmitted together with the first APO key 729. The first APO key 729 is the public key of the first public private key pair. In addition to being transmitted, the first APO key 729 may be stored in the hardware key store 114. The transmitted first APO key 729 may be compared with the stored first APO key 729 in a compare operation 734 that is further described herein. The first APO key 729 may also be used by a signature verification algorithm 738. Inputs to the signature verification algorithm 738 include the encrypted payload 726, the digital signature 728, and the first APO key 729.

The second APO key 722 may be used by a decryption algorithm 739 to decrypt the encrypted payload 726. The decryption algorithm 739 generates a decrypted payload 740. The second APO key 722 may be stored in the hardware key store 114. The second APO key 722 may be stored in an unencrypted format in some embodiments. Alternatively, the second APO key 722 may be stored in the hardware key store 114 in an encrypted format, e.g., as encrypted symmetric key 746, along with the third APO key.

In the alternative in which the third APO key is stored in the hardware key store 114, the second APO key 722 is encrypted using APO public key 742 and encryption algorithm 744. The APO public key 742 is the public key of a second public/private key pair. The encryption algorithm 744 generates the encrypted symmetric key 746. The encrypted symmetric key 746 and the third APO key may be input to a decryption algorithm 748. The third APO key may be the private key of the second public/private key pair. The decryption algorithm 748 generates a decrypted second APO key that may be input to the decryption algorithm 739 and used to decrypt the encrypted payload.

Referring again to FIG. 1, in the given configuration of the processor 101, the crypto engine 102 may decrypt a secure object from the external memory 103 through L2 cache 110 and load it into L1 cache 112 “in the clear” (in a secure environment) for execution by the CPU 104. Although FIG. 1 exemplarily shows the L1 cache 112 as receiving the decrypted secure object information, other configurations are possible, including configurations in which other levels of caches, such as an L2 cache 110, are used to store the secure object while it is “in the clear.” In such alternative configurations, the other levels of cache may also be located to the left of the crypto-engine 102.

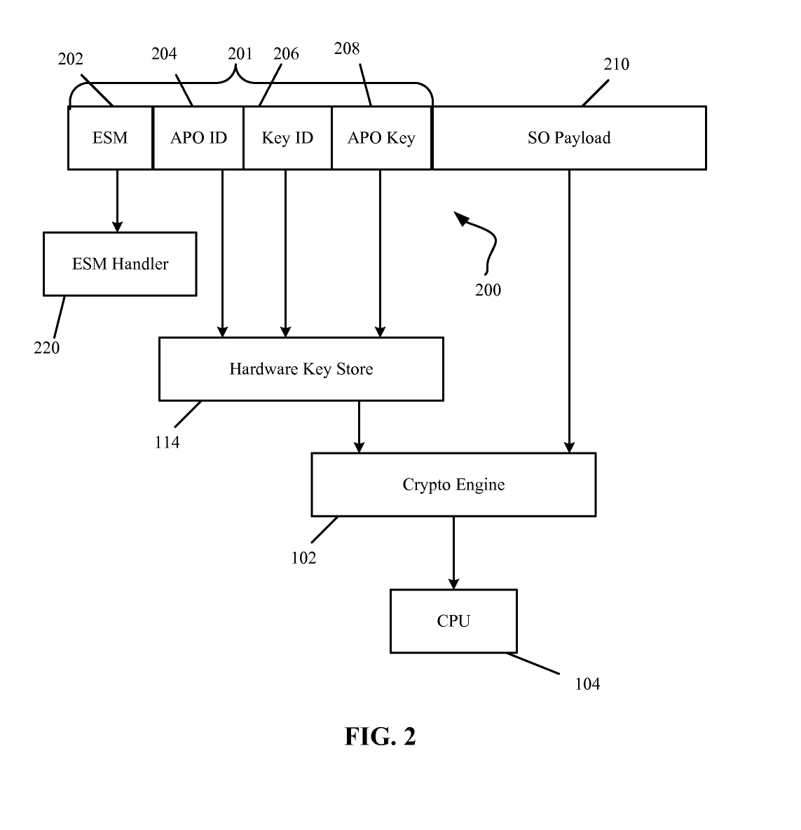

FIG. 2 illustrates an exemplary format of an executable file 200, which includes a secure object, interacting with the process logic of the processor 101, according to an embodiment. The executable file 200 may include the secure object code and data in encrypted form (a secure object payload 210), and an enter secure mode (esm) instruction 201. The esm instruction 201 may include an esm opcode 202, application platform owner (APO) ID 204, a key ID 206, and an APO key 208. Additional digital signatures or wrapped keys may also be included. The esm instruction 201 may allow encrypted information of the secure object to be decrypted on the path from external memory 103 into the CPU 104 and encrypted on the path from CPU 104 to external memory 103. The APO key 208 may be a public key of a public/private key encryption scheme. The secure object payload 210 may include one or more of code, data, stack, and heap data. The executable file 200 may be in a standard executable format, such as executable and linkable format (ELF). The code and data may be encrypted so that only the target CPU 104 can read the executable file 200, and only in secure mode.

In an embodiment, the esm instruction 201 may include an esm opcode 202 to specify to the processor 101 that the executable file 200 includes a secure object payload 210 and to enter secure mode. The esm instruction 201 may also include the APO ID 204, the key ID 206 and the APO key 208 collectively called an owner identification object. The owner identification object may provide access to an APO key stored in the hardware key store 114 for the particular user or application, which may be identical to the APO key 208. In other embodiments, the esm instruction 201 may not include the APO key 208, and the APO key 208 may be solely in the APO key slot of the hardware key store 114

The APO ID 204 and the key ID 206 may be referred to as APO key identifiers collectively. The APO may be a developer or owner of an “application”, e.g. a firmware, bootloader, OS, or application vendor. The APO ID 204 and the key ID 206 may be used locate the correct APO key slot in the hardware key store 114 for the APO. The APO key 208 sent with the secure object payload 210 may be compared with a first APO key that is in the key slot to ensure the correct APO key is being used. This comparison may detect an attack in which the attacker uses an incorrect or out-dated APO key in the executable file 200. Once a comparison is completed, the first APO key in the hardware key store 114 may be used to verify a digital signature of the secure object payload 210. After the digital signature is verified, the key slot of the hardware key store 114 may become unlocked and a second APO key may be retrieved from the slot. The second APO key may be a symmetric key used to decrypt the secure object payload 210 in the crypto-engine 102 and thus the secure object payload 210 may be received by the processor 101. The APO key 208, the second APO key and other APO keys for other application owners may be stored in the hardware key store 114 during an initial registration process and they may be changed when needed.

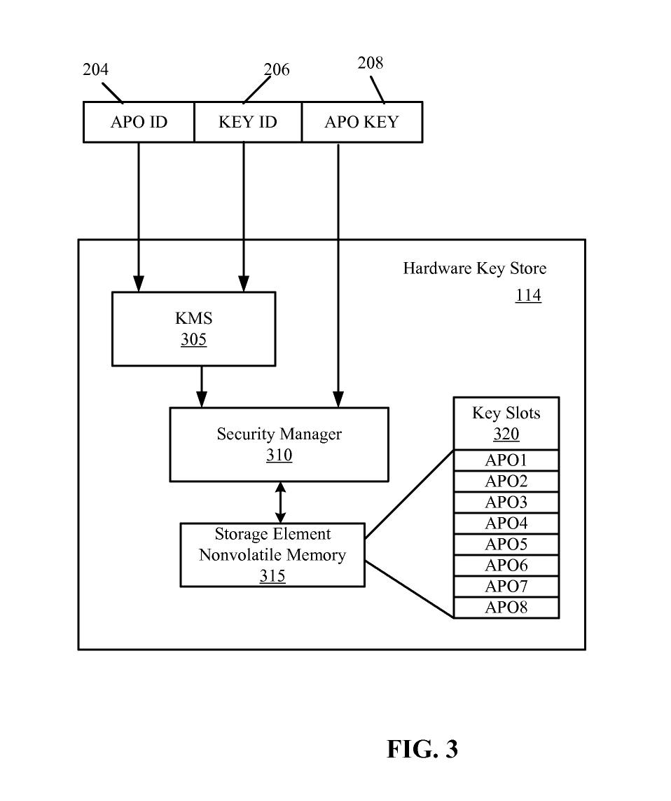

Still referring to FIG. 2, the processing that occurs during execution of the esm instruction 201 with the logic of the processor 101 is illustrated, according to an embodiment. As the executable file 200 enters into the processor 101 from the external memory 103, an esm handler 220 may recognize the esm opcode 202 of the executable file 200. The esm handler 220 may be microcode used to instruct the processor 101 how to handle the esm instruction 201. The processor 101 may be instructed by the esm handler 220 to enter into a secure object execution. The APO ID 204, key ID 206, and APO key 208 of the esm instruction 201 may be sent to a security manager 310 (FIG. 3) to access the second APO key for the APO that was used to encrypt the secure object payload 210. The access of the APO key(s) in the hardware key store 114 is described in more detail in FIG. 3 below.

After the second APO key is accessed, it may be used by the crypto-engine 102 and CPU 104 to decrypt the secure object payload 210 and process the secure object payload 210. The CPU 104 may load the second APO key into the crypto-engine 102 to provide the crypto-engine 102 access to the secure object payload 210 containing the private data and code. The CPU 104 may then execute the secure object private data and code. The one or more APO keys belonging to the APO may not be accessed by any other software. This is because the APO ID 204, key ID 206, and APO key 208 that are used to locate the correct APO key slot should all be unique and the likelihood of a combination that duplicates of all three of the fields should be very low. Also, during a registration process an APO ID may be checked for duplicates, so that no other APO can get access to content of another APO. The executable file 200 is protected by embodiments herein. In another embodiment a secondary protection layer may also be added to the esm hardware and esm instruction to protect the integrity of the executable file 200 as described in co-pending patent application, U.S. patent application Ser. No. 13/033,367, filed on Feb. 23, 2011, to Boivie, et al., entitled “SECURE OBJECT HAVING PROTECTED REGION, INTEGRITY TREE AND UNPROTECTED REGION”

Referring now to FIG. 3, a block diagram of the logic of the hardware key store 114 is illustrated, according to an embodiment. The owner identification object, including the APO ID 204, the key ID 206, and the APO key 208, may be decomposed and the APO ID 204 and the key ID 206 may be directed to a key management system (KMS) 305. The KMS 305 may be an extensible firmware interface key management system (EFI.KMS), in an embodiment. The APO ID 204 and the key ID 206, through the KMS 305, may invoke a security manager 310. The security manager 310 may be code that executes on a microprocessor that is a front-end to a nonvolatile memory 315. In an embodiment, the nonvolatile memory 315 may be a battery backed random access memory (BBRAM), which is one type of NVRAM. In another embodiment, the NVRAM may be flash memory. The nonvolatile memory 315 may include one or more key slots 320 for each APO. Each key slot 320 may contain one or more APO keys (APO1-APO8) for decrypting the secure object payload 210. The APO key APO1 may belong to a first APO. The APO key APO2 may belong to a second APO, and so on. The hardware key store 114 may contain more or less APO key slots than illustrated in alternative embodiments. Also there may be more than one key in each slot in alternative embodiments.

As stated, the security manager 310 may be the frontend to the nonvolatile memory 315 where the security manager 310 provides interface logic, inline database, and interfaces to other modules on the hardware key store 114. The security manager 310 may also be used for external key flash storage if the nonvolatile memory 315 runs out of primary space. In certain embodiments, the nonvolatile memory 315 may have additional features that may include, but are not limited to, quick erase on tampers, non-imprinting memory, environmental sensors for voltage and temperature, and analog gates that may be connected to tamper logic. In another embodiment, the nonvolatile memory 315 may support additional layers of security with access control on the individual or group of key slots 320. Administrator logic may setup the logic of the hardware key store 114 for each of the APOs so that the space configuration is setup and a secret value or password may be configured. Once the preliminary setup is complete, the administrator may have no access to the content, only the configuration of it. The APO may have ownership of the key slot(s) 320 by its IDs and only the security manager 310 may have access to the key slot(s) 320 via an internal bus.

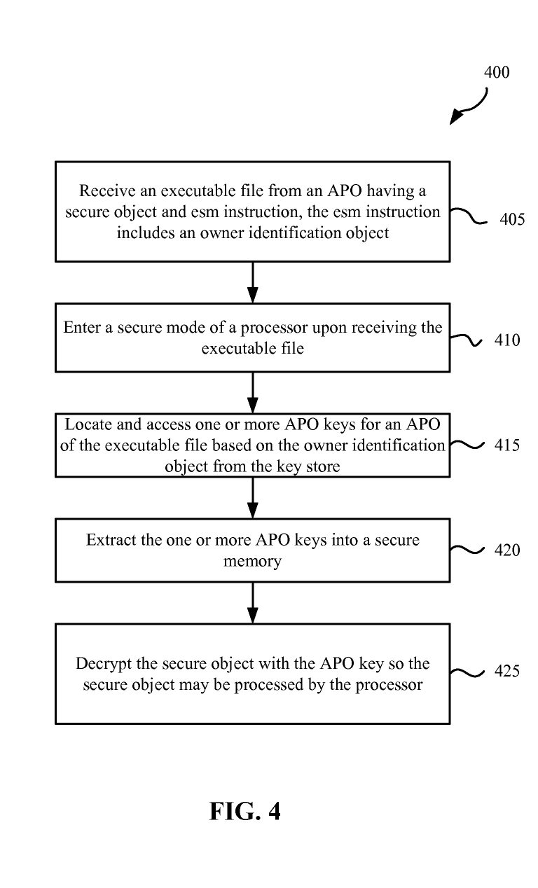

FIG. 4 is a flowchart of a high level method 400 for processing an executable file 200 having a secure object, according to an embodiment. At operation 405, the processor 101 may receive a portion of an executable file 200, such as from a memory 103. The executable file 200 may include a secure object and an esm instruction 201. The esm instruction 201 may include an owner identification object and an esm opcode 202. In operation 410, the processor 101 may enter a secure mode upon receiving and recognizing that the executable file 200 includes a secure object. When entering secure mode the operating system or kernel may suspend while the processor executes the esm instruction 201. Other software may not access the processor 101 while the processor 101 is executing the esm instruction 201. In operation 415, the processor 101 may locate one or more APO keys for the APO of the executable file 200 stored within a hardware key store 114. The APO keys may be found using the information provided in the owner identification object (APO ID 204, key ID 206, and APO key 208). The owner identification object may be decomposed and invoke the KMS 305 to invoke the security manager 310. The security manager 310 may lookup the key slot 320 in the nonvolatile memory 315 for the APO key belonging to the APO of the executable file 200, and the security manager 310 may unlock the key slot 320 to gain access to APO keys in the key slot 320. Operation 415 may include comparing the APO key 208 with a first APO key stored in the key slot 320. In operation 420, the one or more APO keys may be extracted from the hardware key store 114 and copied into a secure memory. In operation 425, a second APO key may be used to decrypt the secure object. The processor 101 may decrypt the secure object payload 210 with the second APO key. The processor 101 may execute the decrypted secure object code.

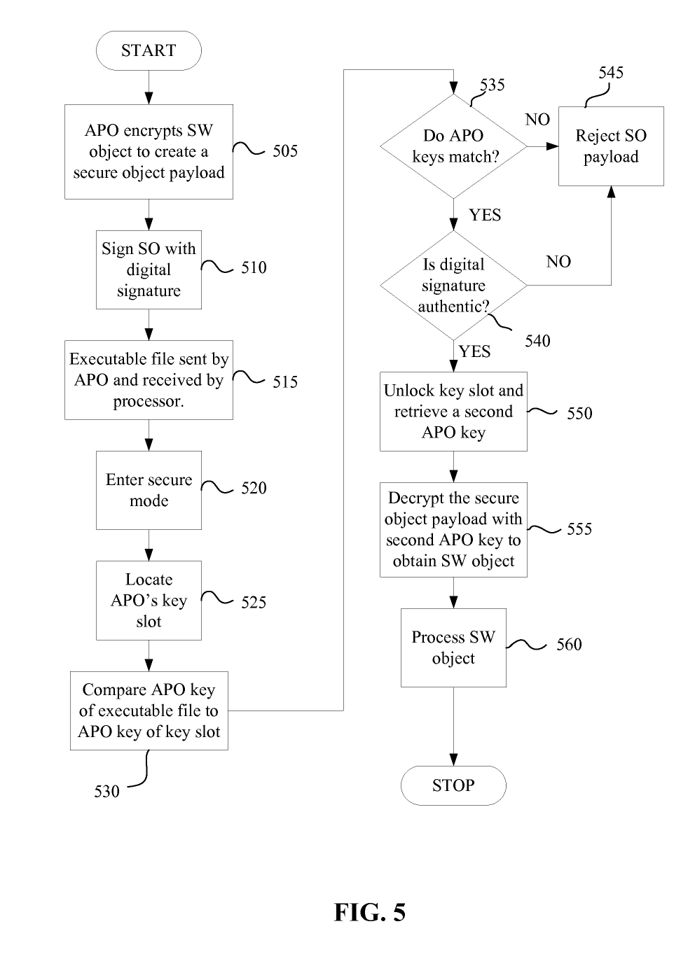

FIG. 5 illustrates a flow chart of a method 500 of a key scheme that may be used with the system 100, according to an embodiment. In operation 505, an APO may encrypt a software package of code or data or both, for example, with a second APO key to create a secure object payload. The second APO key may be a symmetric key. In operation 510, a digital signature for the secure object payload may be generated at the APO using a signing algorithm and a private key of a public/private key pair. A public key, e.g., a first APO key, that can verify the digital signature may be sent along with the secure object payload as APO key 208. In other embodiments, the public key is only in the key store 114 in the APO's key slot 320 and not sent with the secure object. Other items may be attached to the secure object payload to make up the executable file such as the key ID and APO ID. In operation 515, the executable file is sent to and received by the processor 101. The processor 101 upon receiving the executable file and recognizing it has a secure object, enters a secure mode in operation 520.

In operation 525, the key ID and APO ID may be used to locate the APO's key slot in the hardware key store 114 by using the KMS 305 and security manager 310 to locate the key slot 320 in the nonvolatile memory 315. In operation 530, once the key slot 320 is located for the APO, the APO key 208 sent with the secure object payload 210 may be compared with the first APO key in the key slot 320 and it may be determined whether they match, in operation 535. In operation 540, if they match, the first APO key in the key slot may verify the digital signature of the secure object payload 210. If they do not match, then, in operation 545, the secure object payload may be rejected. In operation 550, if the digital signature is accepted, then a second APO key in the key slot 320 may be retrieved by the processor 101. The second APO key may be a copy of the symmetric key used to encrypt the software object at the APO. If the digital signature is not verified, then, in operation 545, the secure object payload may be rejected. In operation 555, the secure object payload may be decrypted by the crypto engine using the second APO key. In operation 560, the processor may use the secure object payload 210.

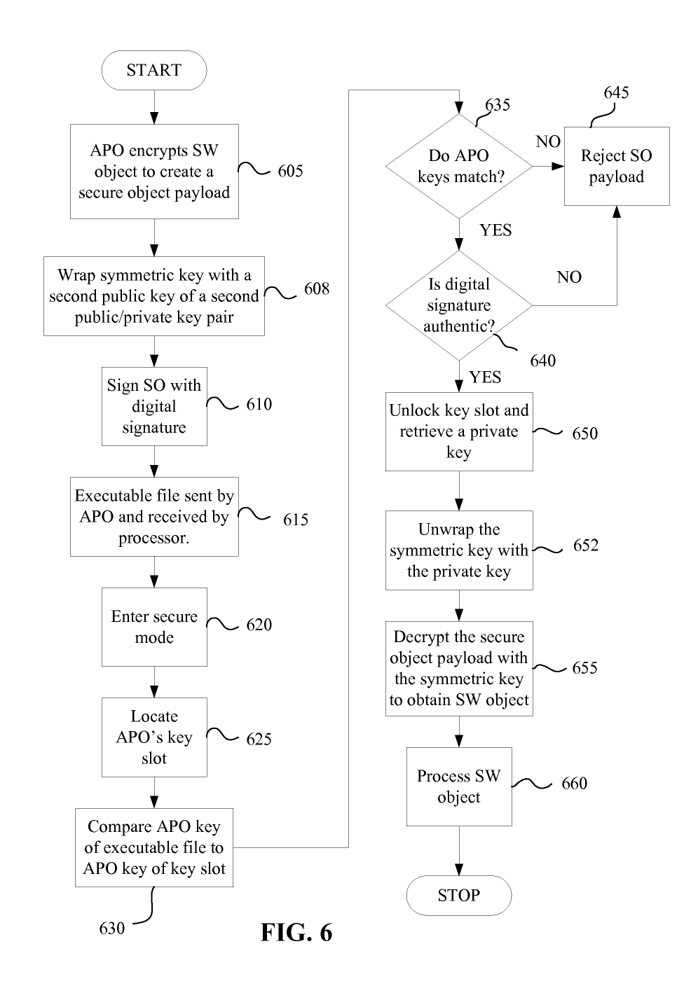

FIG. 6 illustrates a flow chart of a method 600 of an alternative key scheme that may be used with the system 100, according to an embodiment. In operation 605, an APO may encrypt a software package of code or data, for example, with a symmetric key, e.g., a second APO key, to create a secure object payload. In operation 608, the symmetric key (second APO key) may be wrapped by a second public key of a second public/private key pair. In operation 610, a first private key of a first public/private key pair, at the APO, may sign the secure object payload with a digital signature using a signing algorithm and a first public key of a first public/private key pair. The wrapped symmetric key may be included with the SO payload 210 or may be sent separately. A first public key that can verify the digital signature may be sent along with the secure object payload as APO key 208. In other embodiments, the first public key is only in the key store 114 in the APO's key slot and not sent with the secure object. Other items may be attached to the secure object payload to make up the executable file such as the key ID and APO ID. In operation 615, the executable file is sent to and received by the processor 101. The processor 101, upon receiving the executable file and recognizing it has a secure object, enters a secure mode in operation 620.

In operation 625, the key ID and APO ID may be used to locate the APO's key slot in the hardware key store 114 by using the KMS 305 and security manager 310 to locate the key slot 320 in the nonvolatile memory 315. In operation 630, once the key slot 320 is located for the APO the APO key 208 sent with the secure object payload 210, if an APO key 208 was in fact sent with the secure object payload 210, may be compared with the first APO key in the key slot 320 to determine whether they match, in operation 635. In operation 640, if they match, the first APO key in the key slot may verify the digital signature of the secure object payload 210. If they do not match, then the secure object payload may be rejected, in operation 645. In operation 650, if the digital signature is accepted, then a private key, e.g., third APO key, of the second public/private key pair may be retrieved from the key slot 320. In operation 652, the third APO key may be used to unwrap the symmetric key sent to the processor 101 from the APO. If the digital signature is not verified then the secure object payload may be rejected, in operation 645. In operation 655, the secure object payload 210 may be decrypted by the unwrapped symmetric key, e.g., the second APO key. In operation 560, the processor may use the secure object payload 210.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be used. The computer readable medium may be a computer-readable signal medium or a computer-readable storage medium. The computer readable signal medium or a computer readable storage medium may be a non-transitory medium in an embodiment. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire, optical fiber cable, RF, etc., or any suitable combination of the foregoing.

Computer program code for carrying out operations for aspects may be written in any combination of one or more programming languages, including an object-oriented programming language such as Java, Smalltalk, C++ or the like and conventional procedural programming languages, such as the C programming language or similar programming languages. The program code may execute entirely on the user's computer, partly on the user's computer, as a stand-alone software package, or on one module or on two or more modules of a storage system. The program code may execute partly on a user's computer or one module and partly on a remote computer or another module, or entirely on the remote computer or server or other module. In the latter scenario, the remote computer other module may be connected to the user's computer through any type of network, including a local area network (LAN) or a wide area network (WAN), or the connection may be made to an external computer (for example, through the Internet using an Internet Service Provider).

Aspects are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function or act specified in the flowchart, or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions or acts specified in the flowchart, or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

While embodiments have been described with reference to the details of the embodiments shown in the drawings, these details are not intended to limit the scope of the invention as claimed in the appended claims.

What is claimed is:

1. A method of securely transferring objects from an application platform owner to a computer system, comprising:
receiving, from a first memory, an executable file of a first application platform owner (APO), the executable file including an owner identification object and an encrypted secure object payload;
storing one or more keys of two or more APOs on a key store having a nonvolatile key slot for each respective APO;
identifying a first key slot in the key store corresponding with the owner identification object, the first key slot being associated with the first APO,
determining whether the executable file is authentic using a first key from the first key slot.

2. The method of claim 1, further comprising:
decrypting the encrypted secure object payload using a second key if the executable file is determined to be authentic.

3. The method of claim 1, further comprising:
storing a decrypted secure object payload in a secure memory if the executable file is determined to be authentic.

4. The method of claim 1, wherein the executable file further includes a first key.

5. The method of claim 1, wherein the first key is stored in the first key slot.

6. The method of claim 1, wherein the second key of the first APO is stored in the first key slot.

7. The method of claim 1, wherein the key store further includes a security manager configured to securely manage the key slots, the security manager accesses the one or more keys of the APO.

8. The method of claim 1, wherein the owner identification object includes an APO identifier and a key identifier.

9. The method of claim 1, wherein the executable file includes a digital signature used to authenticate the executable file.

10. The method of claim 1, wherein the executable file includes an encrypted key to decrypt the encrypted secure object payload.
